(19) United States
(12) Patent Application Publication
(10) Pub. No.: US 2011/0219037 A1
(43) Pub. Date: Sep. 8, 2011

(54) High-Performance Persistence Framework

(75) Inventor: Michael P. Card, Manlius, NY (US)

(73) Assignee: SRC, INC., North Syracuse, NY (US)

(21) Appl. No.: 12/717,380

(22) Filed: Mar. 4, 2010

(51) Int. Cl. G06F 17/00; G06F 7/00

(52) U.S. Cl. 707/792; 707/812; 707/E17.055; 707/E17.005

(57) ABSTRACT

A high-performance object database wherein an application fetches an object from a database and the high-performance persistence framework constructs the object in memory. The database is programmed with a class that allows the application to selectively activate objects referenced by the class rather than automatically activate all referenced objects. The application selectively activates these referenced objects using read or write methods depending on whether the objects will be modified. Upon completion of the transaction, only those objects that were modified are written to disk. This high-performance persistence framework provides an object database capable of storing a large number of interconnected objects on disk and accessing them without having to activate all of the connected objects while simultaneously indexing the objects in a large number of independent dimensions all at once for fast data retrieval with complex queries.

### BACKGROUND OF THE INVENTION

1. Field of the Invention

The present invention relates to computer database systems, and, more specifically, to a high-performance Java™ object database.

2. Description of the Related Art

With increased digitization and storage of information, the demand for efficient object-based computer database management systems has grown considerably. The size and use of these databases has increased significantly as individuals and organizations attempt to manage and mine ever-increasing amounts of information.

Object database management systems (“ODBMS”) use object-oriented programming languages to facilitate interactions with stored information. One of the most common object-oriented programming languages is Java, which was created by Sun Microsystems™ in the 1990s. ODBMS s that use Java make it possible to directly store Java objects that would normally exist only in a computer's main memory onto disk so that these objects continue to exist even when the program that created them terminates. These objects can then be later retrieved and used by the same or another Java program when it opens the database. Like almost all object-oriented programming languages, Java employs classes to define a set of objects and serve as a template for the creation of objects.

A vital aspect of an efficient ODBMS is transparent persistence, which is the ability of the management system to manipulate objects in an object database using an object-oriented programming language. Without persistent storage, objects would only exist only in the RAM memory of a computer and would not survive loss of power or other faults. Using a traditional ODBMS, objects are ‘activated’ when they are needed. That is, the objects are copied from persistent storage to the RAM of the computer system.

Transparent persistence generally implies that programming language pointers are used to link persistent object together. This is done by storing a persistent address in the pointer attribute within an object at the time it is stored in the database. Later, when the object is fetched from the database the ODBMS reads the persistent address from the pointer attribute and uses it to find the referenced object in persistent storage. It then copies the object into memory and replaces the persistent address in the pointer attribute with the object's address in RAM. The application then uses the pointer to access the linked object just as it would with any other programming language object. The problem with this is that programming languages do not provide “hooks” to let a program know when a pointer has been used to access an object. Therefore, since the ODBMS will not know when a pointer between two objects is traversed by a program, it is blind to updates made this way. As a result, the ODBMS must assume that updates were made and copy the objects back out to persistent storage at commit time or require the application to manually re-store the objects, which will likely result in unnecessary writes to persistent storage

Activation of a top-level object will result in a chain activation of all referenced objects, resulting in a huge tree copied from persistent storage to memory. This network of objects can be taxing on an application and on RAM capabilities. To limit the activation of every referenced object in a network of objects, some products such as db4o™ allow a developer to set an “activation depth” which limits how much of an object graph the ODBMS will traverse when it copies objects from persistent storage into main memory. Developers can also manually activate and deactivate objects to main memory.

These approaches, however, require that all code that dereferences an inter-object pointer must first determine whether the object is activated and then activate it if necessary. Although this is an improvement over activation of an entire object network, it still requires a substantial commitment of memory to the ODBMS. As a result, there is still a demand for the ability to activate only objects that are needed without committing a significant amount of memory.

### BRIEF SUMMARY OF THE INVENTION

It is therefore a principal object and advantage of the present invention to provide a database capable of storing a large number of interconnected objects on disk and accessing them without having to activate all the connected objects.

It is a further object and advantage of the present invention to provide an object database capable of simultaneously indexing the objects in a large number of independent dimensions for extremely fast data retrieval even with complex queries.

In accordance with the foregoing objects and advantages, the present invention provides a high-performance Java™ object database capable of: (a) storing a large number of interconnected objects on disk and accessing them without having to activate all of the connected objects; (b) simultaneously indexing the objects in a large number of independent dimensions all at once for fast data retrieval with complex queries.

The present invention further provides a high-performance object database wherein: (1) an application fetches an object from a database and the high-performance persistence framework constructs the object in memory; (2) the application activates DBref-linked objects using read or write methods depending on whether the objects will be modified; (3) upon completion of the transaction, only those objects that were modified are written to disk.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a graphical representation of one embodiment of the present invention.

FIG. 2 is a representation of an application fetching an object from a database and the high-performance persistence framework constructing it in memory.

FIG. 3 is a representation of an application activating objects linked to the fetched object via the DBref linker.

FIG. 4 is a representation of modified objects being written to disk after a transaction is done and commits.

FIG. 5 is a representation of activation of only those objects required by the application.

### DETAILED DESCRIPTION OF THE INVENTION

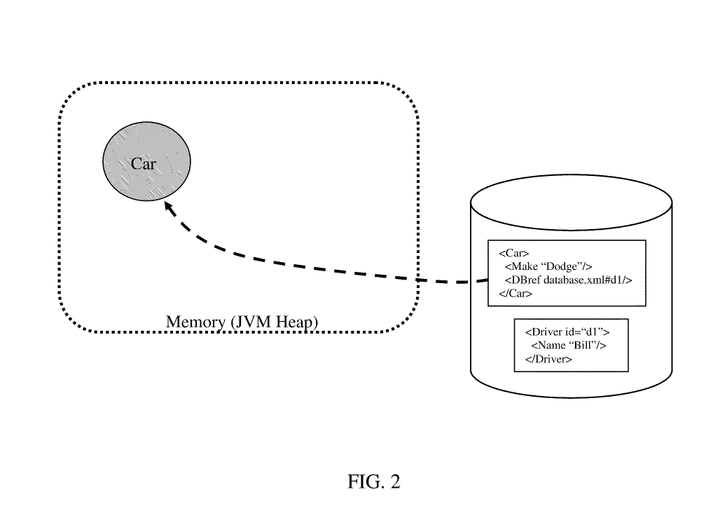

Referring now to the drawings, wherein like reference numerals refer to like parts throughout, there is seen in Figure a flowchart representing one embodiment of the present invention. As an initial step 10, an application fetches or retrieves an object from a database. In FIG. 2, the application is retrieving the Car object from the database, which references a Driver object using a class according to the present invention. Almost all object-oriented programming languages use classes to define a set of objects and serve as a template for the creation of objects. The present invention includes a new class called the DBref class which is used to link together persistent objects that the user wants to be activated separately. In FIG. 2, the Car object references the Driver object using a DBref. As a result, when the Car object is activated the Driver object will not be activated unless the application calls for it.

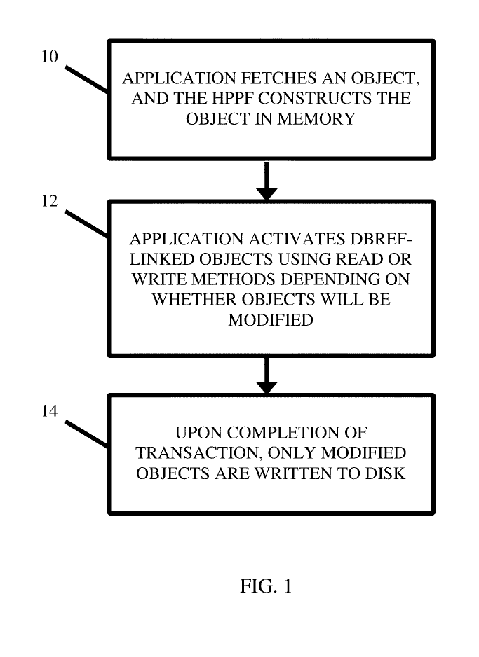

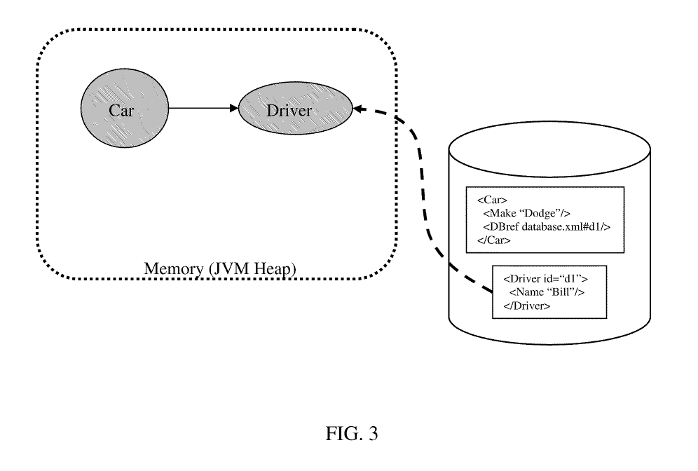

In step 12 of FIG. 1, the application activates DBref-linked objects using traditional read( ) or write( ) methods, depending upon whether the activated objects will be modified. In FIG. 3, the application is directed to change the driver name from “Bill” to “Mike.” The application fetches the Car object, which does not result in automatic activation of the Driver object since the objects are linked with the DBref class. Instead, the application separately activates the Driver object and creates an in-memory copy which is placed in the transaction's write list. The high-performance persistence framework links the in-memory Car and Driver copies together with a pointer, and the Driver object's Name Attribute is changed.

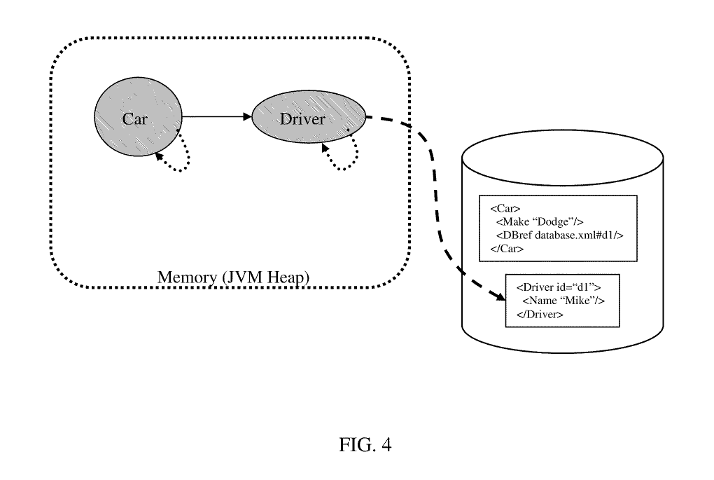

In step 14 of FIG. 1, after a transaction is completed and it commits, any modified objects (i.e. those that were put in the transaction's write list by a call to DBref.write( ) for example) are written to disk, as shown in FIG. 4. After the program commits the transaction, the high-performance persistence framework writes the modified objects listed on the transaction's write list out to disk; here, the Driver object is written to disk.

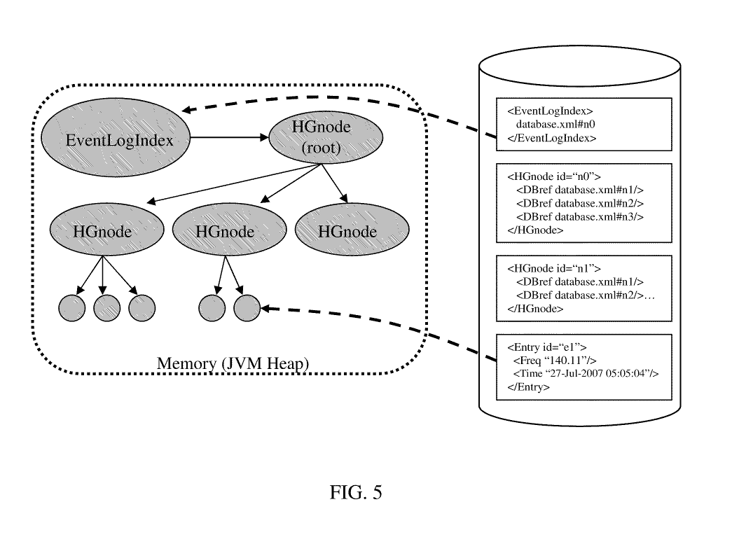

FIG. 5 shows the functional advantage of the present invention. As a result of the DBref class, activation of a top-level object such as “EventLogIndex” in the figure does not cause a chain activation of all referenced objects in the database. Instead, because many of these objects are referenced using the DBref class, the referenced objects are only activated on demand. The high-performance persistence framework thereby allows an application to possess and navigate very large interconnected networks of objects in an optimal way to limit memory usage. It also allows an application to form a “spatial index” on the objects which allows them to be searched in many dimensions at once for fast access in data-intensive applications like data mining, signal processing, and pattern recognition.

From the point of view of a developer or programmer, the present invention requires a limited number of changes for implementation. The first required changes involve class declarations. The following is an example of code using traditional methods:

```
public class Car {
        Driver driver;
        String make;
        Car (String make) {
              this.make =
              new String (make);
        }
}
```

The following is an example of the same code employing the present invention:

```
public class Car implements HpfSerializable {
        DBref driver;
        String make;
        Car (String make) {
                this.make =
                new String (make);
        }
        Car ( ) { ... }
        public byte [ ] toBytes( ) { ... }
        public void fromBytes (byte[ ] obj) { ... }
}
```

As the example shows, implementation of the DBref class requires that the developer: (1) implement HpfSerializable interface; (2) use DBref for linking separately-activated objects; (3) include a no-argument constructor; and (4) implement the toBytes and fromBytes methods required by the HpfSerializable interface.

The high-performance persistence framework also employs different application code. The following is an example of application code according to traditional methods:
myCar.driver.setName (“Mike”);

The following is an example of the same application code employing the present invention:

Transaction myTrans = new Transaction (false);
myCar.driver.write(myTrans) .setName (“Mike”);

As the example shows, when using the high-performance persistence framework, the developer must: (1) create a Transaction object to access persistent objects; and (2) use the read( ) and write( )methods of the DBref to get a pointer to the object that can be dereferenced using the programming language.

Other aspects of the application code are different when using the high-performance persistence framework. The following is an example of application code according to traditional methods:

myDB.store (myCar.driver);
myDB.store (myMomsCar.driver);
myDB.store (myGarage);
myDB.store (myCarKeys.location);
myDB.store (myObjectThatChanged);

The following is an example of the same application code employing the present invention:
myTrans.commit ( );

As the example shows, the high-performance persistence framework must only commit the transaction rather than remember what changed and restore those objects.

Although the present invention has been described in connection with a preferred embodiment, it should be understood that modifications, alterations, and additions can be made to the invention without departing from the scope of the invention as defined by the claims.

What is claimed is:

1. A method for managing an object database in response to a request from an application, the method comprising:
storing a plurality of objects in a persistent data store;
linking a first object in said persistent data store to at least a second object in said persistent data store with a selective activation class;
loading at least a first object from said persistent data store to a main memory;
loading the second object from said persistent data store to said main memory, wherein if the second object is linked to the first object by said selective activation class the second object is not loaded into main memory unless the application requests it; and
storing at least the first and second objects back into the persistent data store.

2. The method of claim 1, wherein loading said first or second object from said persistent data store to said main memory further comprises loading said object into main memory using a read function.

3. The method of claim 1, wherein loading said first or second object from said persistent data store to said main memory further comprises loading said object into using a write function.

4. The method of claim 3, wherein loading said first or second object from said persistent data store to said main memory further comprises loading said object into a write list of the application.

5. The method of claim 3, wherein the step of storing into the persistent data store further comprises loading back into the persistent data store only those objects loaded into the main memory by the write function.

6. A system for managing an object database in response to a request issued an application, the system comprising:
means for storing a plurality of objects in a persistent data store;
means for linking a first object in said persistent data store to at least a second object in said persistent data store with a selective activation class;
means for loading the first object from said persistent data store to a main memory;
means for loading the second object from said persistent data store to said main memory, wherein if the second object is linked to the first object by said selective activation class the second object is not loaded into main memory unless the application requests it; and
means for storing at least the first and second objects back into the persistent data store.

7. The system of claim 6, wherein the loading means load said first or second objects from the persistent data store to the main memory using a read function.

8. The system of claim 6, wherein the loading means load said first or second objects from the persistent data store to the main memory using a write function.

9. The system of claim 8, further comprising means to load said first or second object into a write list of the application.

10. The system of claim 8, wherein the storing means loads back into the persistent data store only those objects loaded into the main memory by the write function.

11. A high performance object persistence framework comprising:
a central processing unit;
a main memory store;
a persistent data store comprising a plurality of stored objects;
an object database manager, wherein the object database manager comprises an object loading component adapted to load a first stored object from said persistent data store to said main memory in response to a request from an application, and further adapted to load a second object from said persistent data store to said main memory, wherein if the second object is linked to the first object by a selective activation class the second object is not loaded into main memory unless the application requests it; and
an object storage component adapted to store at least the first and second objects back into the persistent data store.

12. The high performance object persistence framework of claim 11, wherein the object loading component loads said first or second objects from the persistent data store to the main memory using a read function.

13. The high performance object persistence framework of claim 11, wherein the object loading component loads said first or second objects from the persistent data store to the main memory using a write function.

14. The high performance object persistence framework of claim 13, wherein the object loading component loads said first or second object into a write list of the application.

15. The high performance object persistence framework of claim 13, wherein the object storage component loads back into the persistent data store only those objects loaded into the main memory by the write function.
